(19) United States
(12) Patent Application Publication
(10) Pub. No.: US 2003/0033332 A1
(43) Pub. Date: Feb. 13, 2003

(54) Control/display unit page builder software tool

(76) Inventor: Steven E. Lindsley, Albuquerque, NM (US)

Correspondence Address: Honeywell International Inc., Law Department AB2, P O Box 2245, Morristown, NJ, 07962, US

(21) Appl. No.: 09/908,241

(22) Filed: Jul. 18, 2001

(51) Int. Cl. G06F 17/24

(52) U.S. Cl. 707/526; 707/530

(57) ABSTRACT

The CDU Page Builder is a software tool that provides a means for full life-cycle development of an MCDU page with respect to display format and related key operation. The tool employs a graphical, domain-centered, aircrew-familiar user interface for page definition. The tool is hosted on a cost-effective, widely-available personal computer platform. Once defined, a page may be viewed in the format used for definition or using representative data. Once several pages are defined, the interactions within and between pages can be simulated, thus allowing potential users of a system to experience the look and feel of the ultimate system. Documentation may be associated with the various aspects of the page and then generated in a form suitable for use as software requirements. Finally, the page definition can be used to generate software source code that implements the desired display characteristics and key operation of the page.

### BACKGROUND OF THE INVENTION

1. Field of the Invention (Technical Field)

The invention relates to control/display unit (CDU) pages, and more particularly to a software tool related to specification of a single CDU page and the design of a system of CDU pages and the automatic generation of software to present those pages on a physical CDU and the generation of documentation of all aspects of each CDU page.

2. Background Art

In the past, control/display unit (CDU) pages have been developed using static, manual processes. Generally, this has taken the form of written documents describing the layout and operation of a set of pages. The most notable drawback to this method is the lack of a dynamic view of the system being developed. Another drawback is that the graphical presentation of the page is limited by word processor technology and provides a rendering of the page that can be best described as a “close approximation” of the way that the actual page will appear in the target environment. Once the pages are described in the written document, the task of translating the description into software must occur. Because the pages are described simply in English, it is not uncommon to have ambiguity in the descriptions. This ambiguity causes the translation effort to be error prone. As well as being error prone, the translation to software code is both tedious and laborious. The tasks performed by the CDU page builder are being performed manually today. However, manual processes are tedious, laborious, and error-prone.

The present state of the art is a product called VAPS. This product does not solve the entire problem of disclosing a tool for automatically generating textual and graphical representations of a page for inclusion into a document as claimed in the present invention, but it has been used in the past as an aid to writing specifications of CDU page operation. However, it has been used more as a graphical capture tool than an aid to the entire CDU page development process. It does not have facilities for code or document generation, therefore with this system, one must go through the tedious, laborious, and error-prone process of code and document generation. The present invention is a solution specific to the modeling of MCDU pages and, therefore, can take advantage of the a-priori knowledge of the device and the corresponding environment. VAPS is a general purpose prototyping system that has no facilities for capturing the level of data required to unambiguously specify page constructs and operations, generate documentation, or generate code. The state of the art is shown in the following prior art patents:

U.S. Pat. No. 4,845,495 describes a layout of avionics controls and displays within a cockpit, while the present invention discloses a means for specifying the layout of information on a single display.

U.S. Pat. No. 5,019,980 describes a means of monitoring real-time signals within the aircraft environment; some of which may be a result of communication with an MCDU. The present invention does not address the real-time execution of software on the MCDU. Rather, it deals with a means for specifying the layout of information on an MCDU screen and the generation of software to implement the specification.

U.S. Pat. No. 4,642,775 describes a flight planning system. The present invention deals with a means for specifying the layout of information on an MCDU screen that may be used to generate software implementing requirements for portions of a flight management system or any other system that utilizes an MCDU.

The present invention solves the aforementioned problem by allowing page designers to specify pages using a true-to-life representation of the CDU and by providing facilities that automate the generation of both textual and graphical representations of the page for inclusion into a document.

Past approaches have not been able to enforce consistency among CDU pages and have not attempted to capture all information associated with a CDU page or a system of pages. Because the information has not been captured in a tool, neither code nor document generation has been possible. No other approaches have attempted to unambiguously define the operation of a CDU page and to embody that knowledge into a tool specifically made for that purpose.

### SUMMARY OF THE INVENTION (DISCLOSURE OF THE INVENTION)

In accordance with the present invention, disclosed is a software tool related to specification of a single CDU page and the design of a system of CDU pages and the automatic generation of software to present those pages on a physical CDU and the generation of documentation of all aspects of each CDU page. The preferred method of specifying an operation of a CDU page comprises the steps of defining display and entry characteristics of the CDU page, simulating operation of the CDU page, capturing requirements of the CDU page, generating operator interface requirement documents and generating code to implement the operation of the CDU page. The step of defining display and entry characteristics of the CDU page comprise modeling a display format and specifying an operation of line select keys and mode keys. The step of modeling a display format comprises passing row, column, and length, format, font size, font color, visibility, justification, and sample contents of field information to a page description database. The step of specifying an operation of line select keys and mode keys comprises passing scratchpad usage, page branching information, relationship to an “execute” annunciator, downselect operation, and scratchpad validation rules for the key to a page description database. The preferred method further comprises the step of storing the display and entry characteristics in a page description database. The step of simulating operation of the CDU page comprises presenting representative data, processing simulated key presses, accepting simulated scratchpad entries, and changing pages based on the page definition and the other page definitions currently stored in the page description database. The step of capturing requirements of the CDU page comprises manual entry of the requirements and associated supporting comments in a textual format. The preferred textual format comprises a hypertext format. The step of generating operator interface requirement documents comprises generating documents in graphical, textual and tabular form. The step of generating code to implement operation of the CDU page comprises generating software source code in a predetermined language. The predetermined language can comprise Ada or C.

A primary object of the present invention is to capture the operation of CDU pages.

Another object of the present invention is to generate software to implement the captured operation.

Yet another object of the present invention is to provide basic simulation of the operation of the CDU pages.

A primary advantage of the present invention is that it provides a consistent way to define the operation of CDU pages.

Another advantage of the present invention is that it provides a means to generate software code making it cheaper than present systems.

Another advantage of the present invention is that it is easier to use than the present manual systems.

Yet another advantage of the present invention is that it is more precise than existing methods.

Another advantage of the present invention is that it is more reliable than existing methods.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a diagram of the six major elements involved in the operation of the CDU Page Builder.

FIG. 2 is a block diagram of the embodiment of FIG. 1.

### DESCRIPTION OF THE PREFERRED EMBODIMENTS (BEST MODES FOR CARRYING OUT THE INVENTION)

The CDU Page Builder Software Tool is a utility that supports the development of pages to be displayed on an ARINC-739 standard CDU. The tool is designed to run in a Microsoft Windows desktop environment and provides facilities for the following aspects of page development:

Comprehensive Page Specification

Comprehensive Page Design

Limited page/system simulation

Page documentation generation

Code generation

In the past, CDU pages have been developed using static, manual processes. Generally, this has taken the form of written documents describing the layout and operation of a set of pages. The most notable drawback to this method is the lack of a dynamic view of the system being developed. Another drawback is that the graphical presentation of the page is limited by word processor technology and provides a rendering of the page that can be best described as a “close approximation” of the way that the actual page will appear in the target environment. The CDU Page Builder solves this problem by allowing page designers to specify pages using a true-to-life representation of the CDU and by providing facilities that automate the generation of both textual and graphical representations of the page for inclusion into a document.

Once the pages are described in the written document, the task of translating the description into software must occur. Because the pages are described simply in English, it is not uncommon to have ambiguity in the descriptions. This ambiguity causes the translation effort to be error prone. The CDU Page Builder overcomes this ambiguity by providing capabilities for generating software code directly from the page designers specifications.

The tool supports the full specification of CDU pages in terms of both bezel keys and display fields. The operation of bezel keys is specified in terms of their use of the scratchpad and the actions that are taken upon the activation of the key. The operation of display fields can be fully specified in terms of the dynamicity of the field and the behavior of the field when it is specified as dynamic.

The tool supports the design of a page by providing an intuitive graphical user interface for placing and arranging display fields upon the display surface. Simulation services provided by the tool allow system designers and end users of the resulting systems to experience the look-and-feel of the pages as they would appear in the aircraft environment. The simulation capabilities of the tool include:

Inter-page navigation

Sample data display

Dynamic behavior for display fields (given a fixed display string)

Linking of display fields to simulated key presses

Page documentation facilities include a means to accept textual, “word processor” type inputs to document software requirements for the page. The documentation produced by the tool includes graphical and tabular representations of the page characteristics captured in the tool integrated with the textual software requirements that were entered into the tool.

The code generation facilities provided by the tool are very comprehensive. The tool assumes the existence of the standard display system framework that is provided by the common flight management system (FMS) product line software. Given that framework, the code generation facilities are capable of generating code to process keypresses and to drive display outputs. Where information is required by the generated code to drive the actual display, standard calls are made to services that must be provided by the application development team. A list of the services that an application development team is required to provide is generated as a part of the code generation facilities of the tool. The generated code is designed to be used verbatim by the application development team such that, once the application development team supplied services have been written, the code can be compiled and linked into the surrounding system.

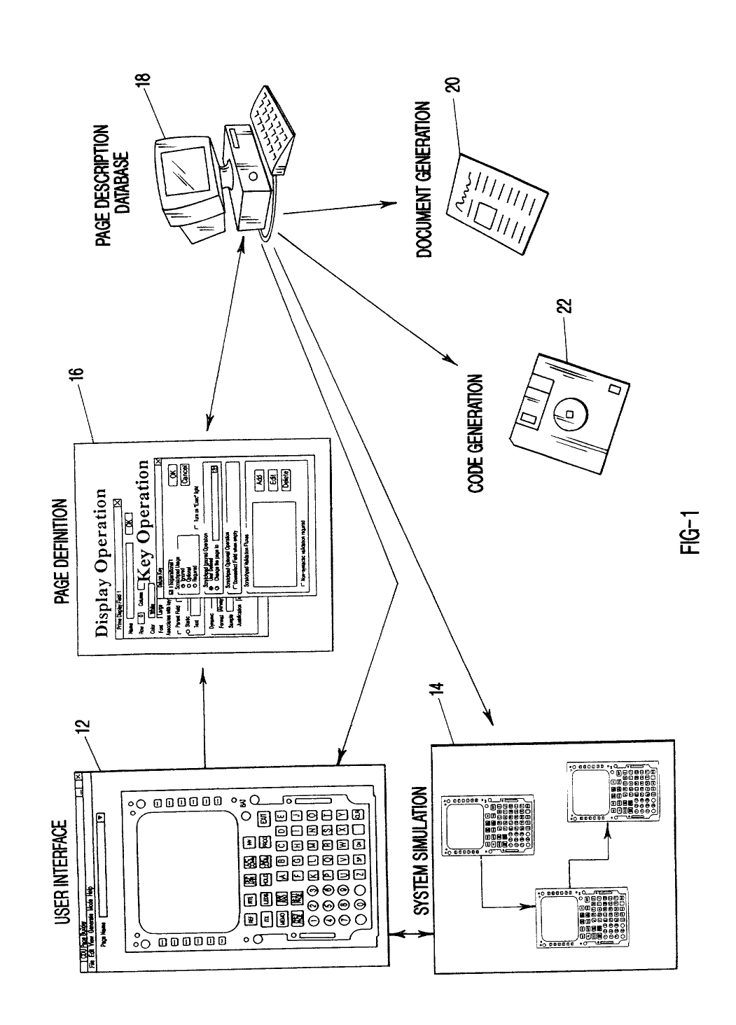

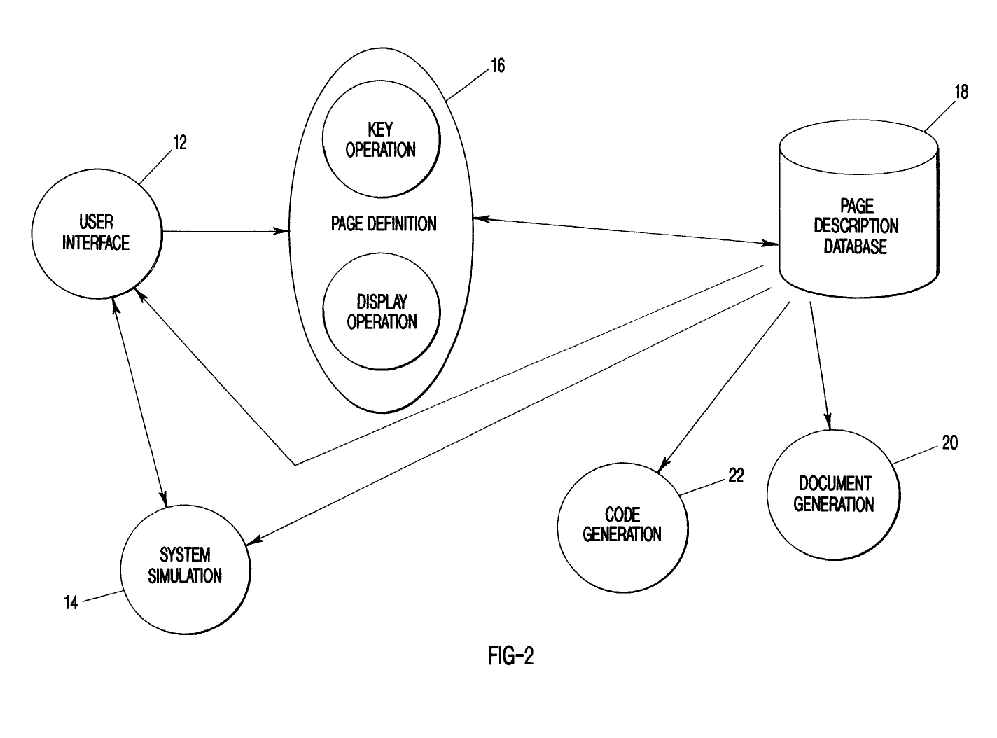

There are six major elements involved in the operation of the CDU Page Builder. These are shown in the diagrams illustrated in FIGS. 1 and 2. The following paragraphs describe the purpose of each block and the communication required with associated blocks.

User interface 12 is the sole means of operating the CDU Page Builder. Some of the operations provided by the CDU Page Builder are user interface-intensive, and others simply employ the user interface 12 to invoke the operation. For instance, page definition requires heavy use of the user interface 12 to describe the details of page operation. However, the code generation block 22 only requires the information stored in the page description database to perform its function; the user of the CDU Page Builder invokes the code generation function by using the menus provided within the user interface 12.

The user interface 12 is employed to start the process of defining both keys and display fields associated with the CDU page being defined. A basic set of information is passed to the page definition block 16 for identification of the entity being defined. For definition of keys, the sole data passed is the key name. For display fields, the information passed is the field number and the row, column, and length of the field. Once the key or display field has been fully defined in the page definition block 16, the user interface 12 is refreshed by reconstructing the page using the page description database.

During system simulation 14, data is passed from the user interface 12 to the system simulation 14 such that the key presses from the user interface 12 can be interpreted by the system simulation 14 and the appropriate system response is generated.

The page definition block 16 consists of a set of input facilities that are used to fully define the operational characteristics of CDU keys and the behavior of CDU display fields. Once defined, the information is stored in the page description database 18 so that it is available to all other facilities in the system. The page definition block 16 is invoked solely by the user interface 12, from which it receives enough information to identify the entity being defined. All information stored in the page description database 18 is populated by the page definition block 16.

The page description database 18 contains all the information necessary to fully specify a CDU page. This includes both the operation of bezel keys while the page is displayed and the fields presented on the display surface while the page displayed. The page description database 18 is capable of storing information for several pages simultaneously such that an entire paging system can be resident. A partial listing of the data stored in the page description database for any given page is shown below:

| General | Display Fields | Keys |
|---|---|---|
| Page Name | Row, Column, Length | Indication of whether the key is |
| | | operational |
| | Font | Scratchpad usage |
| | Color | Scratchpad input validation rules |
| | Indication of whether the | |
| | field is dynamic or static | |
| | Dynamic behavior | |
| | Format of the field | |

The document generation block 20 produces documentation associated with a page that is contained in the page description database 18. Several types of documentation can be produced by this document generation block 20, including page descriptions used within operator interface requirements specifications. Documentation can be produced in a combination of textual, graphical and tabular forms, including hypertext.

The code generation block 22 produces a source code template that can be used to implement the operation of the page in software. Since the code generation block 22 is simply a consumer of data from the page description database 18, it is capable of generating source code in any of several languages and assuming any surrounding environment of page management services. For example, the language can be in Ada, C, or other similar commonly known language. The code generation block 22 is not designed to be capable of generating complete, compilable code because the semantics of the page are not specified via the CDU Page Builder. Rather, the CDU Page Builder generates a template that assumes the existence of a set of basic page management services and a set of subprograms with a pre-defined interface that will be provided by the developer of the operational software.

The system simulation block 14 interprets simulated keypresses that are provided by the user interface 12 and drives the user interface 12 to simulate the display effects of an appropriate response to that keypress. The response that is generated is derived from the information contained in the page description database 18. The simulation capabilities of the CDU Page Builder are most useful to end-users of the resulting system because they can then “navigate” through the system such that they get a true-to-life representation of the operation of the final system. Because of the code generation capabilities of the CDU Page Builder, the end users and the system developers can both be assured that the resulting software will correctly implement the operation that was observed and accepted during the simulation.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A method of specifying an operation of a CDU page, the method comprising the steps of:
a) defining display and entry characteristics of the CDU page;
b) simulating operation of the CDU page;
c) capturing requirements of the CDU page;
d) generating operator interface requirement documents; and
e) generating code to implement the operation of the CDU page.

2. The method of claim 1 wherein the step of defining display and entry characteristics of the CDU page comprise modeling a display format and specifying an operation of line select keys and mode keys.

3. The method of claim 2 wherein the step of modeling a display format comprises passing row, column, and length, format, font size, font color, visibility, justification, and sample contents of field information to a page description database.

4. The method of claim 2 wherein the step of specifying an operation of line select keys and mode keys comprises passing scratchpad usage, page branching information, relationship to an “execute” annunciator, downselect operation, and scratchpad validation rules for the key to a page description database.

5. The method of claim 1 further comprising the step of storing the display and entry characteristics in a page description database.

6. The method of claim 1 wherein the step of simulating operation of the CDU page comprises presenting representative data, processing simulated key presses, accepting simulated scratchpad entries, and changing pages based on the page definition and the other page definitions currently stored in the page description database.

7. The method of claim 1 wherein the step of capturing requirements of the CDU page comprises manual entry of the requirements and associated supporting comments in a textual format.

8. The method of claim 7 wherein the textual format comprises a hypertext format.

9. The method of claim 1 wherein the step of generating operator interface requirement documents comprises generating documents in graphical, textual and tabular form.

10. The method of claim 1 wherein the step of generating code to implement operation of the CDU page comprises generating software source code in a predetermined language.

11. The invention of claim 10 wherein the predetermined language comprises Ada.

12. The invention of claim 10 wherein the predetermined language comprises C.
